(19) United States
(12) Patent Application Publication
(10) Pub. No.: US 2025/0091246 A1
(43) Pub. Date: Mar. 20, 2025

(54) STRETCHING AND CONVEYING DEVICE FOR GREEN COMPACT

(71) Applicant: Panasonic Intellectual Property Management Co., Ltd., Kadoma-shi, Osaka (JP)

(72) Inventor: Satoru Maeda, Kanagawa (JP)

(73) Assignee: Panasonic Intellectual Property Management Co., Ltd., Kadoma-shi, Osaka (JP)

(21) Appl. No.: 18/729,251

(22) PCT Filed: Oct. 19, 2022
(86) PCT No.: PCT/JP2022/038892

§ 371 Date: Jul. 16, 2024

(30) Foreign Application Priority Data
Jan. 18, 2022 (JP) 2022-005859

(51) Int. Cl. B28B 3/12

(52) U.S. Cl. CPC B28B 3/126

(57) ABSTRACT

A stretching and conveying device for a green compact includes a first roll and a second roll structured to convey by rotation the green compact by sandwiching the green compact between the first roll and the second roll and stretch the green compact using a circumferential speed difference between the first roll and the second roll. The second roll has a curvature radius larger than a curvature radius of the first roll, and is positioned downstream of the first roll. The green compact is conveyed while being supported on a circumferential surface of the first roll, delivered to the second roll side at a position where the first roll and the second roll face each other, and conveyed while being supported on a circumferential surface of the second roll.

### CROSS-REFERENCE TO RELATED APPLICATIONS

This application is based upon and claims the benefit of priority from the prior Japanese Patent Application No. 2022-005859, filed on Jan. 18, 2022, and the International Patent Application No. PCT/JP2022/038892, filed on Oct. 19, 2022, the entire content of each of which is incorporated herein by reference.

### BACKGROUND

### Field of the Invention

The present disclosure relates to a stretching and conveying device for a green compact.

### Description of the Related Art

Patent Literature 1 describes a technique of feeding powder (granule) to a gap between a pair of rolls and compressing the powder to obtain a green compact having a sheet shape.

Patent Literature 1: JP 2018-186033

There is a case where the green compact having a sheet shape is conveyed while being supported on a plurality of rolls and the green compact is gradually stretched during conveyance to adjust the thickness of the green compact to a target value. In such a process of stretching and conveying the green compact, when the green compact is delivered from an upstream roll to a downstream roll, the direction of travel of the green compact may greatly change and the green compact may be rapidly bent. A sudden change in curvature of the green compact may cause damage to the green compact. This tendency becomes more significant as the green compact becomes thinner.

### SUMMARY OF THE INVENTION

The present disclosure has been made in view of such a circumstance, and an object thereof is to provide a technique for suppressing damage to a green compact during stretching and conveyance.

An aspect of the present disclosure is a stretching and conveying device for a green compact. The device includes: a first roll and a second roll structured to convey by rotation a green compact in which powder is compressed into a sheet shape by sandwiching the green compact between the first roll and the second roll and stretch the green compact using a circumferential speed difference between the first roll and the second roll, in which the second roll has a curvature radius larger than a curvature radius of the first roll, and is positioned downstream of the first roll in a conveyance direction of the green compact, and the green compact is conveyed while being supported on a circumferential surface of the first roll, delivered to a second roll side at a position where the first roll and the second roll face each other, and conveyed while being supported on a circumferential surface of the second roll.

Any combinations of the above components and modifications of the expressions of the present disclosure between a method, a device, a system, and the like are also effective as aspects of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram of a stretching and conveying device for a green compact according to an embodiment; and

FIGS. 2A and 2B are schematic diagrams for describing stress applied to a green compact during stretching and conveyance.

### DETAILED DESCRIPTION OF THE INVENTION

Hereinafter, the present disclosure will be described on the basis of preferred embodiments with reference to the drawings. The embodiments are not intended to limit the present disclosure but examples, and all features described in the embodiments and combinations thereof are not necessarily essential to the present disclosure. The same or equivalent components, members, and processing illustrated in the drawings are denoted by the same reference numerals, and redundant description is omitted as appropriate.

In addition, the scale and shape of each portion illustrated in each drawing are set for convenience in order to facilitate the description, and are not limitedly interpreted unless otherwise specified. In addition, when the terms “first”, “second”, and the like are used in the present specification or claims, unless otherwise specified, these terms do not represent any order or importance, and are intended to distinguish one configuration from another configuration. In addition, in each drawing, some of the members that are not important for describing the embodiments are omitted.

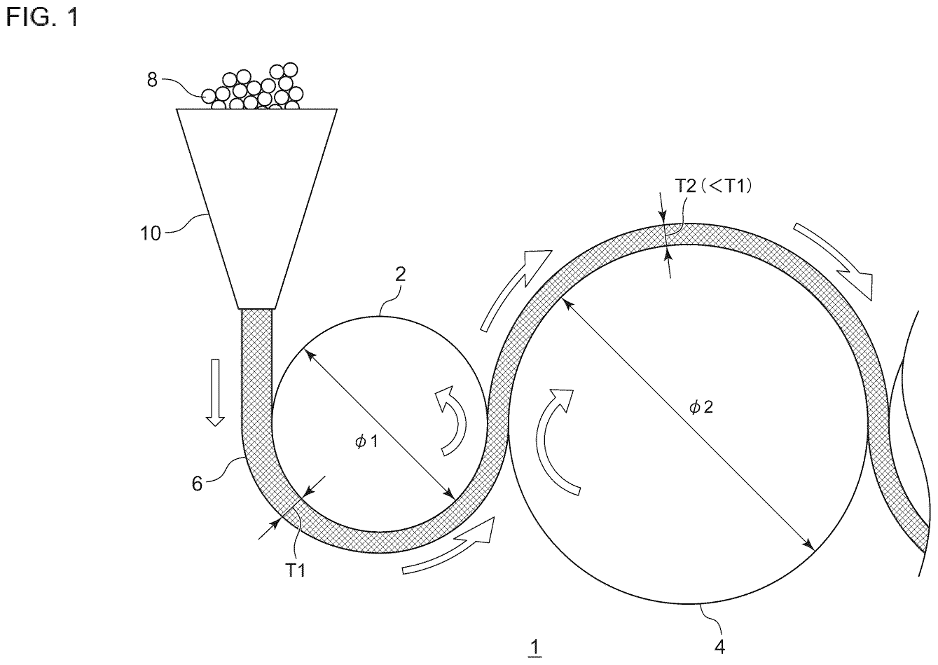

FIG. 1 is a schematic diagram of a stretching and conveying device 1 for a green compact 6 according to an embodiment. The stretching and conveying device 1 for the green compact 6 (hereinafter, appropriately abbreviated as “stretching and conveying device 1”) includes a first roll 2 and a second roll 4. The orientations of the first roll 2 and the second roll 4 are set so that their rotation axes are parallel to each other, and the first roll 2 and the second roll 4 are adjacent at a predetermined interval. In addition, the second roll 4 is disposed downstream of the first roll 2 in a conveyance direction of the green compact 6.

A diameter φ2 of the second roll 4 is larger than a diameter φ1 of the first roll 2. For example, the diameter φ1 of the first roll 2 is 100 mm to 200 mm, and the diameter φ2 of the second roll 4 is 300 mm to 400 mm. Accordingly, the second roll 4 has a curvature radius larger than a curvature radius of the first roll 2. Preferably, the curvature radius of the second roll 4 is twice or more the curvature radius of the first roll 2.

The green compact 6 passes through a gap between the first roll 2 and the second roll 4. The green compact 6 is obtained by compressing powder 8, which is a source material, into a sheet shape. As an example, the green compact 6 is compressed and formed by an extruder 10 extruding the powder 8 through a hole having a rectangular shape. The green compact 6 is continuously sent from the extruder 10 to the stretching and conveying device 1. Accordingly, the green compact 6 has a belt shape elongated in the conveyance direction. Note that the green compact 6 may be formed with a combination of a feeder that feeds the powder 8 and a pair of pressure rolls that compresses the powder 8 fed from the feeder into a sheet shape.

The powder 8 constituting the green compact 6 contains predetermined particles and a binding component that binds the particles to each other. The binding component includes at least one of a known binding agent (binder) or a solvent. In addition, in the powder 8 as an example, the content of the binding component is 20 mass % or less, 10mass % or less, or 1 mass % or less with respect to the total mass of the powder 8. For example, the total content of the binding agent and the solvent is 20 mass % or less, 10 mass % or less, or 1 mass % or less with respect to the total mass of the powder 8. That is, the powder 8 as an example is dry powder.

The first roll 2 and the second roll 4 can convey the green compact 6 by rotating in opposite directions with the green compact 6 interposed therebetween. Note that the first roll 2 and the second roll 4 as an example convey the green compact 6 only by sandwiching the green compact 6 between the first roll 2 and the second roll 4 without having a mechanism for sucking the green compact 6 on the circumferential surfaces thereof.

In addition, the first roll 2 and the second roll 4 rotate at circumferential speeds different from each other. Specifically, the rotation speed of the second roll 4 is faster than the rotation speed of the first roll 2. As a result, the green compact 6 can be conveyed, and the green compact 6 can be stretched by a circumferential speed difference therebetween. That is, the first roll 2 and the second roll 4 are stretching and conveying rolls. Accordingly, thickness T2 of the green compact 6 positioned on the circumferential surface of the second roll 4 becomes smaller than thickness Tl of the green compact 6 positioned on the circumferential surface of the first roll 2. For example, the thickness of the green compact 6 is 100 to 2000 μm when extruded from the extruder 10, and is reduced to 50 to 200 μm by the stretching and conveying device 1. Preferably, the thickness of the green compact 6 after being thinned by the stretching and conveying device 1 is 200 times or less the particle diameter of the powder 8. The green compact 6 is conveyed while being supported on the circumferential surface of the first roll 2, and is delivered to the second roll 4 side at a position where the first roll 2 and the second roll 4 face each other. Then, it is conveyed while being supported on the circumferential surface of the second roll 4. Accordingly, when the green compact 6 is transferred from the circumferential surface of the first roll 2 to the circumferential surface of the second roll 4, the direction in which the green compact 6 curves is switched to the opposite direction. The green compact 6 being stretched and conveyed is always kept in contact with the circumferential surface of the first roll 2 and the circumferential surface of the second roll 4.

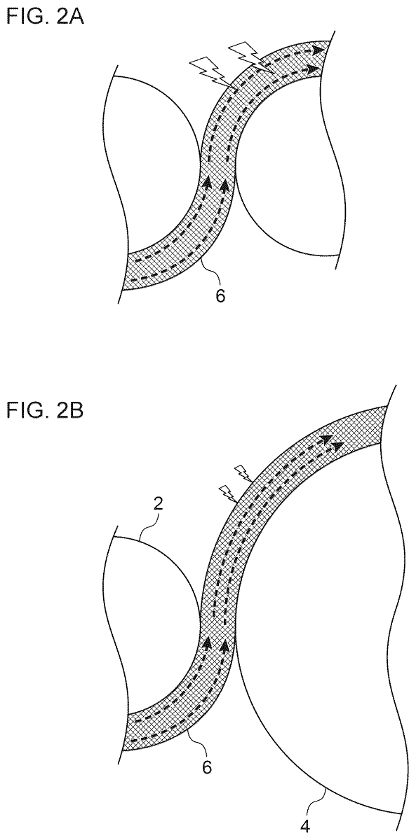

FIGS. 2A and 2B are schematic diagrams for describing stress applied to the green compact 6 during stretching and conveyance. As illustrated in FIG. 2A, when the pair of rolls that convey the green compact 6 have the same curvature radius, the curvature of the green compact 6 rapidly changes when the green compact 6 is delivered from the circumferential surface of the upstream roll to the circumferential surface of the downstream roll, and a large stress is applied to the green compact 6. If such stress becomes excessive, the green compact 6 may be damaged. In particular, when the green compact 6 is stretched while being conveyed, the thickness of the green compact 6 delivered to the downstream roll is reduced. As a result, the amount of the binding component contained in the green compact per unit area of the roll circumferential surface is reduced, so that the green compact 6 is more easily damaged.

On the other hand, as illustrated in FIG. 2B, with the stretching and conveying device 1 of the present embodiment, the curvature radius of the second roll 4 positioned on the downstream side in the conveyance direction of the green compact 6 is larger than the curvature radius of the first roll 2 positioned on the upstream side. This makes it possible to reduce a change in curvature when the green compact 6 is delivered from the circumferential surface of the first roll 2 to the circumferential surface of the second roll 4. Therefore, since the stress applied to the green compact 6 can be reduced, it is possible to suppress damage to the green compact 6 during stretching and conveyance.

Although only one combination of the first roll 2 and the second roll 4 is illustrated in FIG. 1, the stretching and conveying device 1 may include a plurality of such combinations. The plurality of combinations are arranged in the conveyance direction of the green compact 6, and the green compact 6 is sequentially delivered from the upstream combination to the downstream combination. In this case, the sum of the curvature radius of the first roll 2 and the curvature radius of the second roll 4 in each combination is preferably larger for a combination positioned on the downstream side in the conveyance direction. As described above, the damage to the green compact 6 can be further suppressed by increasing the sum of the curvature radii of the combination of the stretching and conveying rolls as the thickness of the green compact 6 decreases. Note that, in any combination, the sum of the curvature radii is preferably 150 mm or more.

In addition, the stretching and conveying device 1 may include a plurality of, three or more, stretching and conveying rolls that are continuously disposed in the conveyance direction of the green compact 6 and stretch and convey the green compact 6. The plurality of stretching and conveying rolls also include the first roll 2 and the second roll 4. As an example, the plurality of stretching and conveying rolls are disposed such that their axes are positioned on the same plane. The green compact 6 meanders while being supported on the circumferential surface of each stretching and conveying roll. In such a configuration, when one or more stretching and conveying rolls are disposed upstream of the first roll 2 in the conveyance direction, the curvature radius of the one or more stretching and conveying rolls is preferably equal to or less than the curvature radius of the first roll 2. In addition, when one or more stretching and conveying rolls are disposed downstream of the second roll 4 in the conveyance direction, the curvature radius of the one or more stretching and conveying rolls is preferably equal to or larger than the curvature radius of the second roll 4. As a result, the damage to the green compact 6 can be further suppressed.

The green compact 6 stretched and conveyed by the stretching and conveying device 1 may be subjected to compression treatment. For example, a pressure roll may be provided at a position facing the second roll 4 so that the green compact 6 passes through between the second roll 4 and the pressure roll and the green compact 6 is compressed.

In addition, the green compact 6 may be stacked on the other sheet material such as a base material. For example, a stacking roll for conveying the other sheet material is provided at a position facing the second roll 4, and the green compact 6 is stacked on the sheet material supported on the circumferential surface of the stacking roll. Note that the stacking roll is preferably separated from the first roll 2 and the second roll 4. If the first roll 2 or the second roll 4 also serves as the stacking roll for conveying the other sheet material, stretching of the green compact 6 may be hindered by the other sheet material. Accordingly, it is preferable that the green compact 6 stretched by the first roll 2 and the second roll 4 is stacked on the sheet material conveyed by the stacking roll separated from the first roll 2 and the second roll 4.

In addition, when the green compact 6 can maintain the shape in a state of being not supported on the roll circumferential surface, the stacking roll may be disposed at a distance from the combination of the first roll 2 and the second roll 4, and the green compact 6 may be conveyed without being in contact with any roll in a section from the combination to the stacking roll. Note that the stacking roll in this case may be configured by a combination of a first stacking roll for conveying the other sheet material and a second stacking roll disposed at a position facing the first stacking roll to bond the green compact 6 to the other sheet material.

In addition, a thin film of a material different from the powder 8 may be formed on the surface of the green compact 6. Examples of the formation of the thin film include stacking of the green compact made of a powder different from the powder 8, spraying of a powder different from the powder 8, and formation of a wet coating film by die coating or inkjet coating. In addition, any non-contact treatment may be performed on the green compact 6. Examples of the non-contact treatment include plasma discharge treatment, corona discharge treatment, electron beam treatment, and the like. For example, a discharge treatment device may be provided at a position facing the second roll 4, and the green compact 6 supported on the circumferential surface of the second roll 4 may be subjected to the discharge treatment.

The use purpose of the green compact 6 is not particularly limited. As an example, the green compact 6 is an electrode mixture layer used for a lithium ion secondary battery or the like. In this case, the powder 8 contains an electrode active material as predetermined particles, and the green compact 6 is stacked on a current collector plate. In addition, the green compact 6 may be a hydrogen storage sheet or the like used for a fuel cell or the like.

As described above, the stretching and conveying device 1 for the green compact 6 according to the present embodiment continuously conveys the green compact 6 by rotation of the first roll 2 and the second roll 4 while supporting the green compact 6 on the circumferential surfaces of both rolls. In addition, the green compact 6 is stretched and thinned using a circumferential speed difference between the rolls. Then, with the stretching and conveying device 1, the curvature radius of the second roll 4 positioned on the downstream side in the conveyance direction of the green compact 6 is set to be larger than the curvature radius of the first roll 2 positioned on the upstream side. As a result, even when the amount of the binding component contained in the green compact 6 placed on the unit area of the roll circumferential surface decreases due to thinning of the green compact 6, it is possible to suppress damage to the green compact 6 at the time of delivery from the first roll 2 to the second roll 4. Thus, damage to the green compact 6 during stretching and conveyance can be suppressed. In particular, when the powder 8 is dry powder in

which the content of the binding component is 20 mass % or less, there is a high possibility that the green compact 6 is damaged during stretching and conveyance as compared with the case where the powder 8 is wet powder because the binding component is originally small. For this reason, the stretching and conveying device 1 of the present embodiment can exert the function particularly effectively when the powder 8 is dry powder. Note that the powder 8 may be wet powder in which the content of the binding component is more than 20 mass %.

The embodiments of the present disclosure have been described above in detail. The above-described embodiments are merely specific examples for carrying out the present disclosure. The contents of the embodiments do not limit the technical scope of the present disclosure, and many design changes such as change, addition, and deletion of the components can be made without departing from the spirit of the present disclosure defined in the claims. A new embodiment to which a design change is made has the effects of each of the combined embodiment and modification. In the above-described embodiments, the contents for which such a design change can be made are emphasized with notations such as “of the present embodiment” and “in the present embodiment”, but the design change is even in contents without such notations. Any combination of the components included in each embodiment is also effective as an aspect of the present disclosure. The hatching applied to the cross sections in the drawings does not limit the material of the hatched target.

The embodiments may be specified by the items described below.

### First Item

A stretching and conveying device (1) for a green compact (6), the stretching and conveying device (1) including:

a first roll (2) and a second roll (4) structured to convey by rotation a green compact (6) in which powder (8) is compressed into a sheet shape by sandwiching the green compact (6) between the first roll (2) and the second roll (4) and stretch the green compact (6) using a circumferential speed difference between the first roll (2) and the second roll (4),

in which

the second roll (4) has a curvature radius larger than a curvature radius of the first roll (2), and is positioned downstream of the first roll (2) in a conveyance direction of the green compact (6), and

the green compact (6) is conveyed while being supported on a circumferential surface of the first roll (2), delivered to a second roll (4) side at a position where the first roll (2) and the second roll (4) face each other, and conveyed while being supported on a circumferential surface of the second roll (4).

### Second Item

The stretching and conveying device (1) according to the first item, including:

a plurality of combinations of the first roll (2) and the second roll (4),

in which

a sum of the curvature radius of the first roll (2) and the curvature radius of the second roll (4) in each combination is larger for a combination positioned on a downstream side in the conveyance direction.

### Third Item

The stretching and conveying device (1) according to the first or second item, including:

three or more stretching and conveying rolls including the first roll (2) and the second roll (4), the stretching and conveying rolls structured to be disposed continuously in the conveyance direction and stretch the green compact (6) while conveying the green compact (6),

in which

when the stretching and conveying roll is disposed upstream of the first roll (2) in the conveyance direction, a curvature radius of the stretching and conveying roll is equal to or smaller than the curvature radius of the first roll (2), and when the stretching and conveying roll is disposed downstream of the second roll (4) in the conveyance direction, the curvature radius of the stretching and conveying roll is equal to or larger than the curvature radius of the second roll (4).

### Fourth Item

The stretching and conveying device (1) according to any one of the first to third items, in which the powder (8) contains predetermined particles and a binding component, and a content of the binding component is 20 mass or less with respect to a total mass of the powder (8).

1. A stretching and conveying device for a green compact, the stretching and conveying device comprising:
a first roll and a second roll structured to convey by rotation a green compact in which powder is compressed into a sheet shape by sandwiching the green compact between the first roll and the second roll and stretch the green compact using a circumferential speed difference between the first roll and the second roll,
wherein
the second roll has a curvature radius larger than a curvature radius of the first roll, and is positioned downstream of the first roll in a conveyance direction of the green compact, and
the green compact is conveyed while being supported on a circumferential surface of the first roll, delivered to a second roll side at a position where the first roll and the second roll face each other, and conveyed while being supported on a circumferential surface of the second roll.

2. The stretching and conveying device according to claim 1, comprising:
a plurality of combinations of the first roll and the second roll,
wherein
a sum of the curvature radius of the first roll and the curvature radius of the second roll in each combination is larger for a combination positioned on a downstream side in the conveyance direction.

3. The stretching and conveying device according to claim 1, comprising:
three or more stretching and conveying rolls including the first roll and the second roll, the stretching and conveying rolls structured to be disposed continuously in the conveyance direction and stretch the green compact while conveying the green compact,
wherein
when the stretching and conveying roll is disposed upstream of the first roll in the conveyance direction, a curvature radius of the stretching and conveying roll is equal to or smaller than the curvature radius of the first roll, and when the stretching and conveying roll is disposed downstream of the second roll in the conveyance direction, the curvature radius of the stretching and conveying roll is equal to or larger than the curvature radius of the second roll.

4. The stretching and conveying device according to claim 1, wherein the powder contains predetermined particles and a binding component, and a content of the binding component is 20 mass % or less with respect to a total mass of the powder.
